(19) United States
(12) Patent Application Publication
(10) Pub. No.: US 2026/0044532 A1
(43) Pub. Date: Feb. 12, 2026

(54) SEMANTIC HASH MACHINE LEARNING FOR DUPLICATE TICKET IDENTIFICATION AND ALERTING

(71) Applicant: SAP SE, Walldorf (DE)

(72) Inventors: Shanavas Madeen S, Krishnagir (IN); Rakhi MISHRA, Bangalore (IN)

(21) Appl. No.: 18/800,430

(22) Filed: Aug. 12, 2024

(51) Int. Cl. G06F 16/28; G06F 40/30; G06N 5/01

(52) U.S. Cl. CPC G06F 16/285; G06F 40/30; G06N 5/01

(57) ABSTRACT

A system associated with incident tickets includes an incident ticket data store with electronic records for incident tickets (each including a ticket identifier and descriptive text). An incident ticket framework performs a hash function on the descriptive text to create a semantic descriptive text hash based on a semantic hashing technique. The semantic descriptive text hash is mapped to a cluster of similar incident tickets and the incident ticket identifier and mapped cluster are stored in a condensed hash database. A new incident ticket, including new incident ticket descriptive text, is received from a reporter. A hash function is performed on the new incident ticket descriptive text to create a semantic descriptive text hash using the same semantic hashing technique. Semantically similar incident tickets can then be determined based on clusters in the condensed hash database.

### BACKGROUND

An enterprise may develop applications, such as business applications associated with management, programming, tracking, etc. As an application is being developed, various parties may utilize the application to ensure it is functioning properly. When an anomaly is detected, an “incident ticket” may be generated describing the problems. The ticket may be passed to a programming team to investigate and fix the error, which can be a time-consuming task. Sometimes multiple parties may generate incident tickets reporting the same anomaly. In this case, the programming team might waste a substantial amount of time investigating a ticket only to discover the situation has already been worked on or resolved. Manually determining if a new incident ticket is associated with the same problem as a prior ticket can be a difficult and error prone task – especially when there are a large number of tickets (e.g., an emprise might track millions of incidents).

It would therefore be desirable to provide incident ticket processing that helps detect duplicate tickets in a secure, automatic, and efficient manner.

### SUMMARY

According to some embodiments, methods and systems associated with incident tickets include an incident ticket data store with electronic records for incident tickets (each including an incident identifier and incident ticket descriptive text). An incident ticket framework performs a hash function on the descriptive text to create a semantic descriptive text hash based on a semantic hashing technique. The semantic descriptive text hash is mapped to a cluster of similar incident tickets, and the incident ticket identifier and mapped cluster are stored in a condensed hash database. A new incident ticket, including new incident ticket descriptive text, is received from a reporter. A hash function is performed on the new incident ticket descriptive text to create a semantic descriptive text hash using the same semantic hashing technique. Semantically similar incident tickets can then be determined based on clusters in the condensed hash database.

Some embodiments comprise: means for retrieving an incident ticket identifier and incident ticket descriptive text; means for performing a hash function on the incident ticket descriptive text to create a semantic descriptive text hash based on a semantic hashing technique; means for automatically mapping the semantic descriptive text hash to a cluster of similar incident tickets; and means for storing the incident ticket identifier and the mapped cluster in a condensed hash database.

Other embodiments comprise: means for receiving, by a computer processor of an incident ticket framework from an incident ticket reporter, a new incident ticket including new incident ticket descriptive text; means for performing a hash function on the new incident ticket descriptive text to create a semantic descriptive text hash based on a semantic hashing technique; and means for automatically determining semantically similar incident tickets based on clusters in a condensed hash database.

Some technical advantages of some embodiments disclosed herein are improved systems and methods to provide incident ticket processing that helps detect duplicate tickets in a secure, automatic, and efficient manner.

### BRIEF DESCRIPTION OF THE DRAWINGS

FIG. 1 is an example of some of the parties that might be involved with enterprise application incident tickets according to some embodiments, although embodiments are not so limited.

FIG. 2 is a high-level incident ticket system architecture in accordance with some embodiments.

FIG. 3 is an incident ticket method according to some embodiments.

FIG. 4 is an example of semantic hashing in accordance with some embodiments.

FIG. 5 is an incident ticket workflow according to some embodiments.

FIG. 6 is an incident ticket semantic hash example in accordance with some embodiments.

FIG. 7 is an incident ticket architecture block diagram according to some embodiments.

FIG. 8 is a method associated with incident ticket reporting in accordance with some embodiments.

FIG. 9 is another incident ticket method according to some embodiments.

FIG. 10 is an incident ticket reporting display in accordance with some embodiments.

FIG. 11 is an apparatus or platform according to some embodiments.

FIG. 12 is a portion of an incident ticket data store in accordance with some embodiments.

FIG. 13 illustrates a tablet computer according to some embodiments.

FIG. 14 is an operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

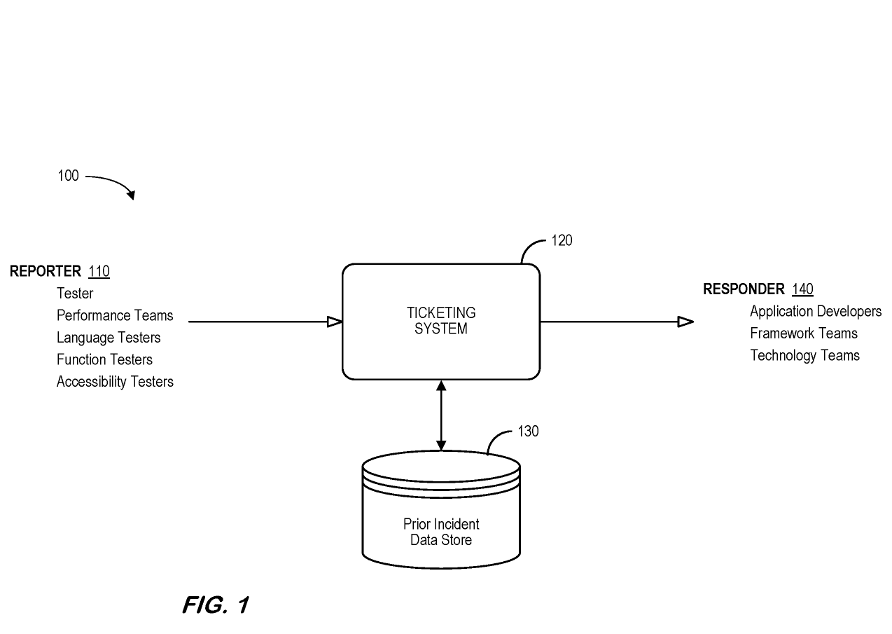

FIG. 1 is an example 100 of some of the parties that might be involved with enterprise application incident tickets according to some embodiments, although embodiments are not so limited. A reporter 110 may generate an “incident ticket,” such as a record of an incident or problem that describes a problem or anomaly in an enterprise application being developed. For example, the reporter 110 might comprise an application tester who generates tickets describing errors that occur during testing (e.g., in connection with a performance team, language testers, functional testers, accessibility testers, etc.). The ticket may be sent from the reporter 110 to a ticketing system 120 that tracks incident tickets. For example, information about a ticket might be stored in a historical prior incident data store 130. Moreover, the ticking system 120 may arrange for information about a new ticket to be provided to a responder 140. The responder 140 might be responsible for investigating the incident and fixing any problems that have been discovered (e.g., in connection with application developers, framework teams, technology teams, etc.).

Both generating a new ticket by a reporter 110 and resolving a ticket by a responder 140 can be time consuming tasks. In some cases, the same problem might have already been sent to the ticketing system 120 (e.g., by another tester). Processing such duplicate tickets can consume a substantial amount of enterprise resources. Manually determining if a new ticket matches one that is already in the prior incident data store 130 is a difficult task. For example, the prior incident data store 130 might store millions of tickets. Moreover, different testers might describe the same problem in different ways.

As part of software application testing activity, a significant percentage of reported incidents may turn out to be duplicates of already existing incidents and there is no proper process in place to avoid such situations. It is not feasible to cross-check every existing incident to find if a similar issue has already been reported before creating a new incident (there can be many combinations making the search very challenging). Especially when it comes to technology or framework issues, this problem is a cause of unnecessary efforts that go into analyzing an incident before it is tagged as a duplicate. In addition, the effort to identify an issue and reporting is also counterproductive when the issue is a duplicate. To reduce this problem, the ticketing system 120 should intelligently inform the reporter 110 about a previously reported identical problem. This would substantially reduce the number of redundant issues, saving time and effort for both the reporters 110 and responders 140 (and standardize the process).

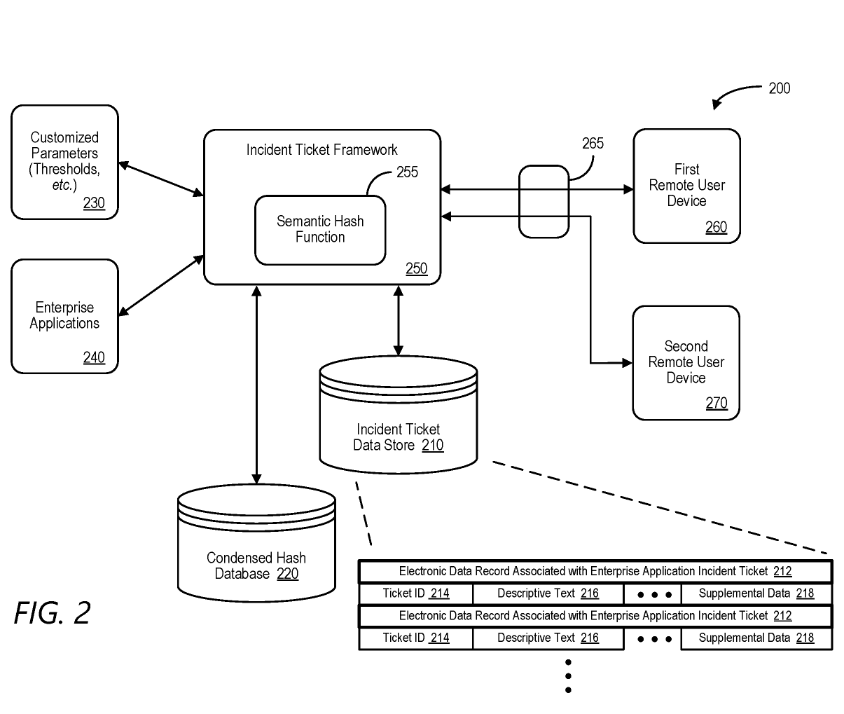

FIG. 2 is a high-level incident ticket system architecture in accordance with some embodiments. In particular, the system 200 includes an incident ticket framework 250 that may access information in an incident ticket data store 210 (e.g., storing a set of electronic records associated with past incident tickets 212, each record including, for example, one or more incident ticket identifiers 214, descriptive text 216 (e.g., explaining the problem), supplemental data 218, etc.). The incident ticket framework 250 may also store information into other data stores, such as a condensed hash database 220, and utilize semantic hash function 255 to exchange and process tickets and view, analyze, and/or update electronic records. The incident ticket framework 250 may also exchange information with a first remote user device 260 and a second remote user device 270 (e.g., via a firewall 265). According to some embodiments, an interactive Graphical User Interface (“GUI”) platform of the incident ticket framework 250 may facilitate the creation and review of incident ticket analysis, recommendations, alerts, and/or the display of results via one or more remote administrator computers (e.g., to summarize system 200 performance) and/or the remote user devices 260, 270. For example, the first remote user device 260 may transmit annotated and/or updated information to the incident ticket framework 250. Based on the updated information, the incident ticket framework 250 may adjust data in the incident ticket data store 210 and/or the condensed hash database 220 and the change may (or may not) be used in connection with the second remote user device 270. Note that the incident ticket framework 250 and/or any of the other devices and methods described herein might be associated with a third party, such as a vendor that performs a service for an enterprise. In some cases, an ingestion engine may exchange information associated with customized parameters 230 and/or enterprise applications 240.

The incident ticket framework 250 and/or the other elements of the system 200 might be, for example, associated with a Personal Computer (“PC”), laptop computer, smartphone, an enterprise server, a server farm, and/or a database or similar storage devices. According to some embodiments, an “automated” incident ticket framework 250 (and/or other elements of the system 200) may facilitate the automated access and/or update of electronic records in the data stores 210, 220 and/or the management of incident tickets. As used herein, the term “automated” may refer to, for example, actions that can be performed with little (or no) intervention by a human.

Devices, including those associated with the incident ticket framework 250 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The incident ticket framework 250 may store information into and/or retrieve information from the incident ticket data store 210 and/or the condensed hash database 220, which may be locally stored or reside remote from the incident ticket framework 250. As will be described further, the incident ticket data store 210 may be used by the incident ticket framework 250 in connection with an interactive user interface to access and update electronic records. Although a single incident ticket framework 250 is shown in FIG. 2, any number of such devices may be included. Moreover, various devices described herein might be combined according to embodiments of the present invention. For example, in some embodiments, the incident ticket framework 250 and incident ticket data store 210 might be co-located and/or may comprise a single apparatus.

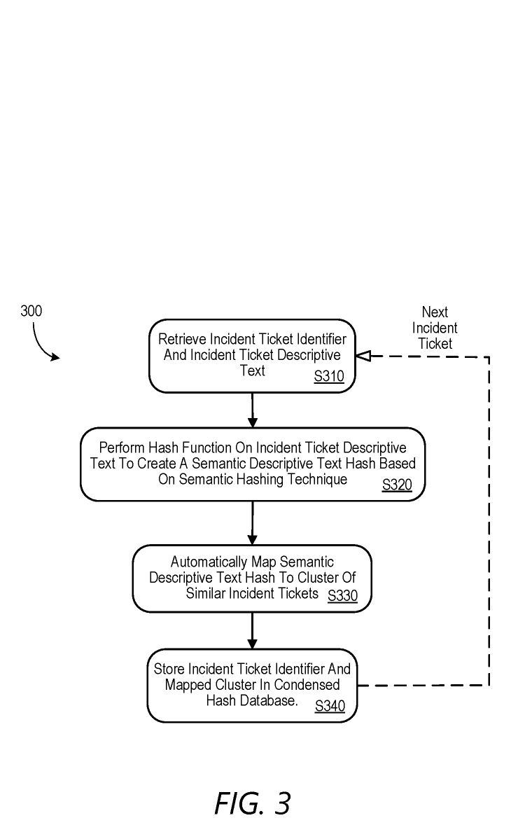

The elements of the system 200 may work together to perform the various embodiments of the present invention. Note that the system 200 of FIG. 2 is provided only as an example, and embodiments may be associated with additional or fewer elements or components. According to some embodiments, the elements of the system 200 automatically transmit information associated with an interactive user interface display over a distributed communication network. FIG. 3 is an incident ticket method 300 that might be performed, for example, by the system of FIG. 2 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

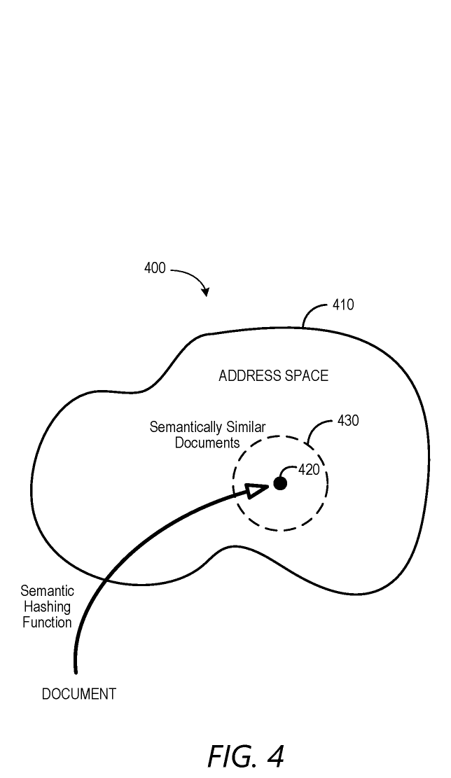

At S310, an incident ticket framework may retrieve an incident ticket identifier and incident ticket descriptive text. These may be retrieved, for example, from a database containing information about thousands or millions of past incidents. As used herein, the terms “incident” and “ticket” both refer, for example, to an item submitted by a reporter. At S320, the incident ticket framework may perform a hash function on the incident ticket descriptive text to create a semantic descriptive text hash based on a “semantic hashing technique.” The semantic hashing technique might be, for example, a contextual condensation process that includes a Machine Learning (“ML”) Natural Language Processing (“NLP”) algorithm. FIG. 4 is an example 400 of semantic hashing in accordance with some embodiments. As used herein, the phrase “semantic hashing” may refer to fixed-length representations where similar pieces of input data have similar hashes. An address space 410 may include documents positioned in accordance with a sematic hashing function. Although the address space 410 of FIG. 4 is two-dimensional, embodiments may be associated with any number of dimensions. When a new document is processed, the same semantic hashing function is used to position the new document 420 in the address space 410. The system may then determine “semantically similar documents” 430 based on their proximity to the new document location 420. In some embodiments, the incident ticket data also stores, for each enterprise application incident ticket, supplemental data such as an enterprise identifier, an application identifier, an incident ticket reporter identifier, an occurrence date, a ticket priority, a ticket status, etc. In this case, the mapped cluster of similar tickets may further be based on the supplemental data.

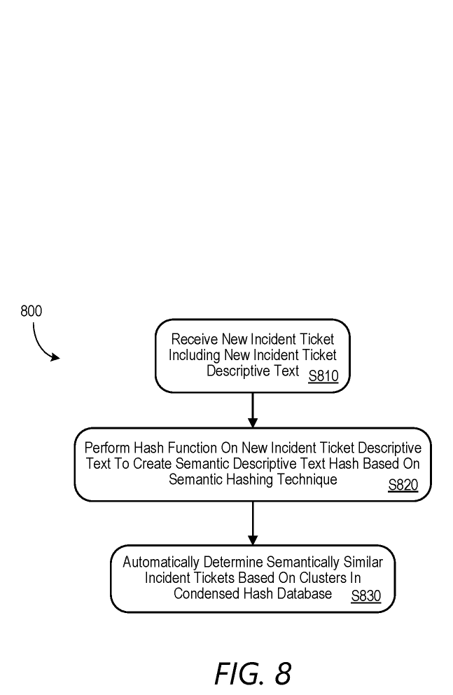

Referring again to FIG. 3, the incident ticket framework automatically maps the semantic descriptive text hash to a cluster of similar incident tickets (e.g. based on a user defined proximity in an address space) at S330. At S340, the incident ticket identifier and the mapped cluster are stored in a condensed hash database. The method may then resume at S310 to process the next incident ticket in the historic database. After all prior incidents have been semantically processed, the incident ticket framework may receive, from an incident ticket reporter, a new incident ticket. The framework can then determine semantically similar incident tickets based on the clusters in the condensed hash database. (e.g., as described with respect to FIG. 8). In some embodiments, the incident ticket framework may provide, to an incident ticket responder, information about the new incident ticket and the semantically similar incident tickets. Similarly, the system might automatically generate an alert message and transmit the message (e.g., to the incident ticket reporter).

Thus, embodiments may provide a ML or Artificial Intelligence (“AI”) powered ticketing system that can detect significant overlaps in information provided by a reporter who is creating a new ticket by comparing the new ticket to information about existing tickets (and notify the reporter about similar issues). This lets the reporter avoid creating the new ticket and burdening the development team unnecessarily. The existing database of a ticket management system can hash, with a semantic hashing technique, every single instance of an incident or ticket description and store the result along with an incident number. The technique can use NLP such semantically similar words and sentences are converted into similar hash/binary codes.

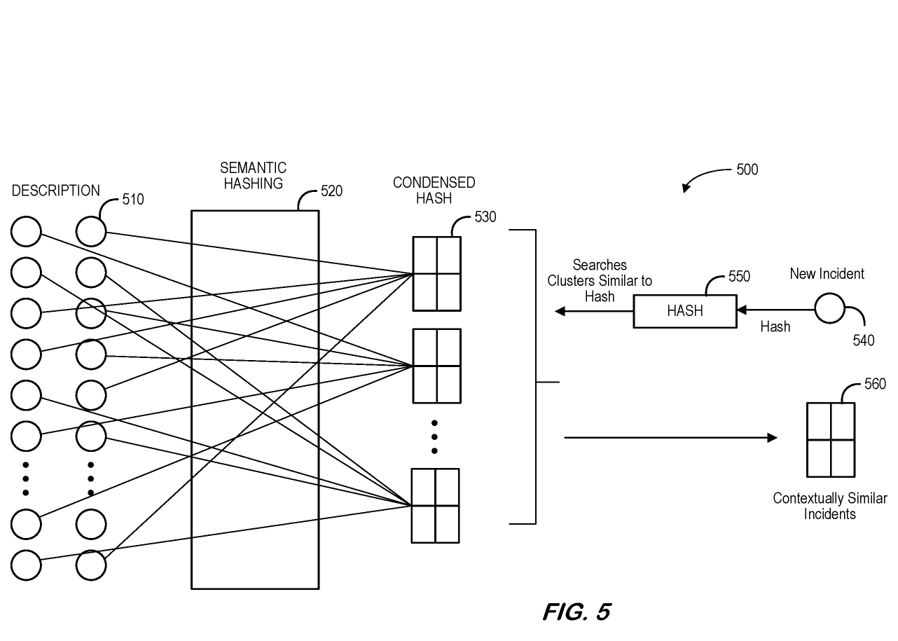

FIG. 5 is an incident ticket workflow 500 according to some embodiments. All the incident descriptions 510 from an incident management database are subjected to semantic hashing 520 (e.g., a contextual condensation process). Moreover, clusters of similar description condensed hashes 530 are stored with each incident’s unique reference that was generated by the incident management system. Once these clusters are available, and a new incident 540 being authored by a reporter uses the same semantic hashing algorithm 550 to hash the new description and retrieve contextually similar incidents 560 from the condensed hash database (and thresholds can be tuned as appropriate).

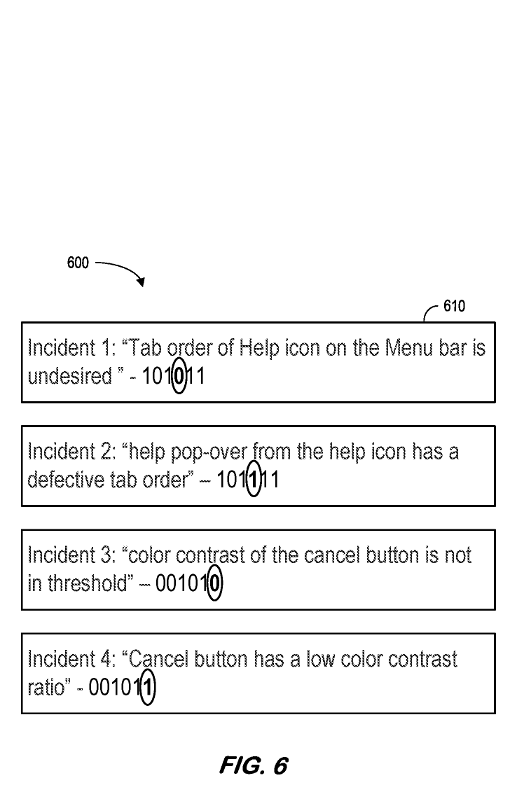

FIG. 6 is an incident ticket semantic hash example 600 for a number of incident tickets 610 in accordance with some embodiments. Incident 1 includes the descriptive text “Tab order of Help icon on the Menu bar is undesired.” This text is semantically hashed resulting in the value “101011.” Incident 2 includes the descriptive text “help pop-over from the help icon has a defective tab order.” For illustration, this text is semantically hashed resulting in the value “101111” (note that the specific values provided herein are only for illustration and might not be result of actual semantic hashing). Since these binary values are very close, with only the fourth digital being different, the system will be able to determine that incident 1 and incident 2 may be related to each other.

Similarly, incident 3 includes the descriptive text “color contrast of the cancel button is not in threshold.” This text is semantically hashed resulting in the value “001010.” Incident 4 includes the descriptive text “Cancel button has a low color contrast ratio.” This text is semantically hashed resulting in the value “001011.” Since these binary values are very close, with only the fourth digital being different, the system will be able to determine that incident 3 and incident 4 may be related. The hashes, however, are more different as compared to incident 1 and incident 2, so the system may determine that these are not related to each other (that is, the values may fall into different clusters).

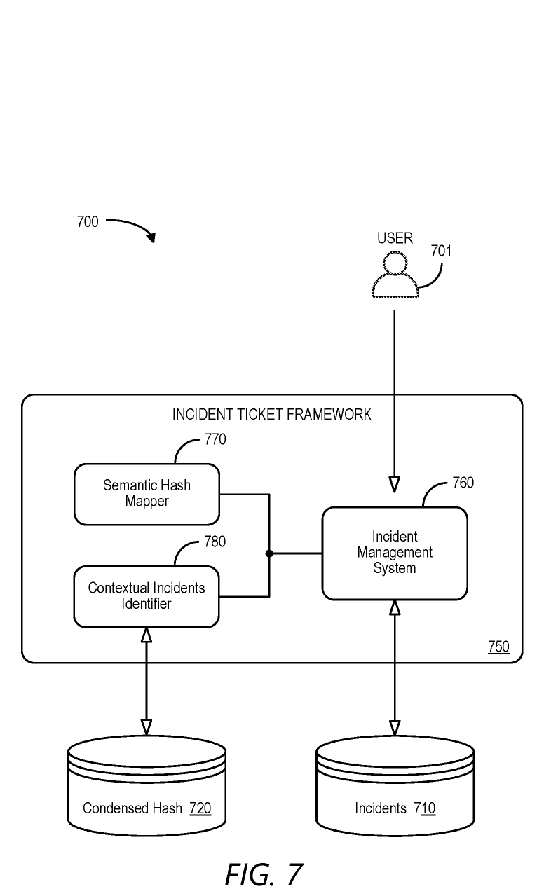

FIG. 7 is an incident ticket architecture block diagram 700 according to some embodiments. An incident ticket framework 750 has an incident management system 760 (and related incidents database 710) that is accessed by a user 701 (e.g., a reporter) to create incidents. A ML model or semantic hash mapper 770 may generate, search, and identify similar incidents. A contextual incidents identifier 780 and a corresponding condensed hash database 720 stores the hash cluster against each of the incident identifiers. When the system is initially established, all of the existing incidents are read from the incident management system 760, hashed against the incident identifier, and stored in the condensed hash database 720. When the user 701 attempts to create a new incident in the incident management system 760, the description is evaluated and all of the comparable description hashes are displayed to the user 701 alongside links to incident. If there are no matches (or user 701 still wishes to create a new incident because the issue is distinct from the proposed existing incidents) then the description is hashed using the same algorithm and stored into the condensed hash database 720 with incident identifier.

FIG. 8 is a method 800 associated with incident ticket reporting in accordance with some embodiments. The method may be performed after all of the historic incident tickets that have occurred were mapped as described in connection with FIG. 2. At S810, an incident ticket framework may receive, from an incident ticket reporter, a new incident ticket including new incident ticket descriptive text. At S820, the incident ticket framework may perform a hash function on the new incident ticket descriptive text to create a semantic descriptive text hash based on a semantic hashing technique. The semantic hashing technique may comprise, for example, a contextual condensation process that includes a ML NLP algorithm. At S830, the framework can then automatically determine semantically similar incident tickets based on the clusters in a condensed hash database.

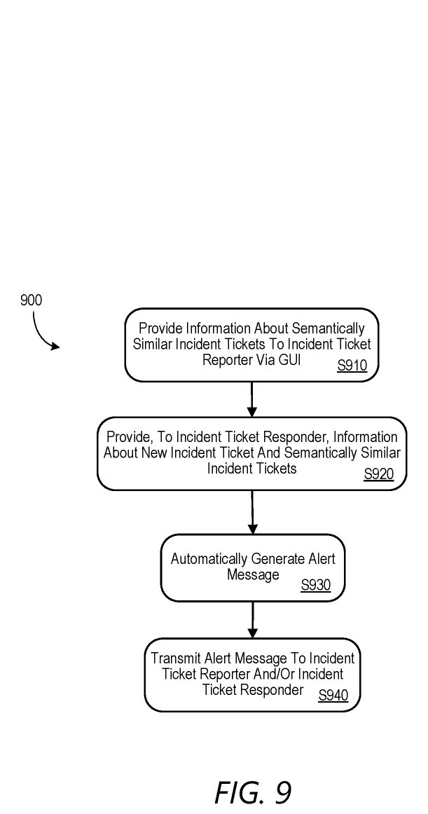

FIG. 9 is another incident ticket method 900 according to some embodiments. The method may be performed, for example, after semantically similar incident tickets for a new ticket have been identified as described in FIG. 8. At S910, the system may provide information about the semantically similar incident tickets to the incident ticket reporter via a GUI. The information about the semantically similar incident tickets may include, for example, links to those incident tickets in the incident ticket data store. The information about semantically similar incident tickets might, in some embodiments, be searchable and/or searchable by an incident ticket reporter to help them identify duplicate tickets. At S920, the system may optionally provide, to an incident ticket responder, information about the new incident ticket and the semantically similar incident tickets. This might help save the responder identify duplicates that were missed by the reporter. At 930, the system may automatically generate an alert message. The message might, for example, state that “**WARNING – Incident 12345 is highly likely to be a duplicate of this new submission.” The various thresholds associated with the alert message may be customizable. At S940, the system may transmit the alert message to the incident ticket reporter and/or incident ticket responder. According to some embodiments, feedback from reporters and/or responders is used to improve performance of the ML algorithm, adjust customized thresholds or other optimizations, etc.

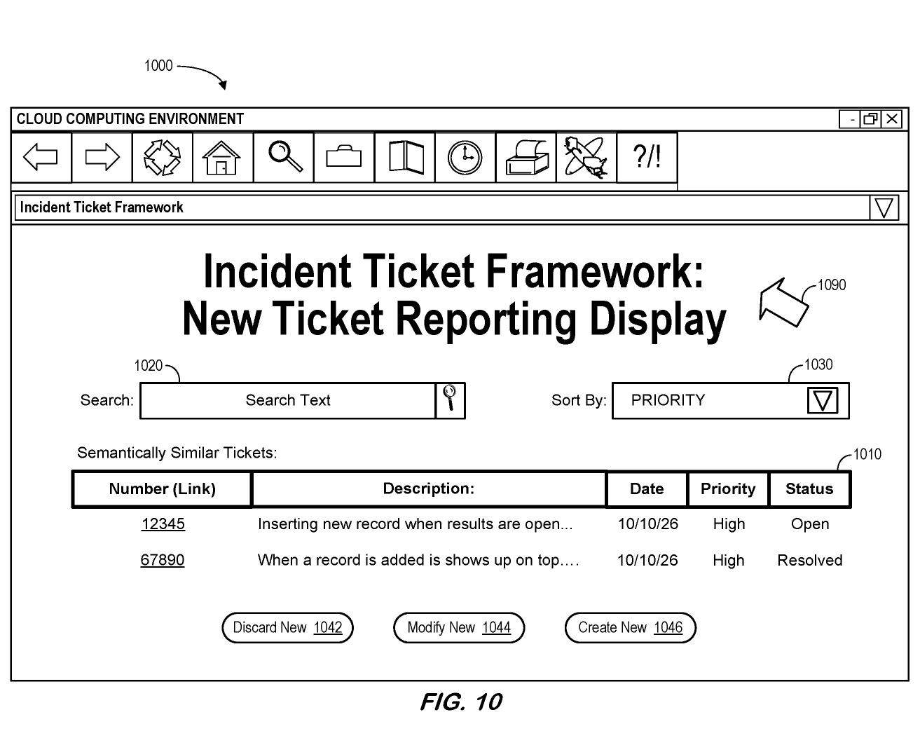

Thus, when the reporter tries to create a ticket, the system validates the similar ticket description using the hash codes stored for all the prior tickets and pulls a list of tickets associated with them based on the text description, status, priority, etc. High dimensional data with millions of records is manageable by bucketing them towards similar hash codes based on the context. For example, FIG. 10 is a new incident ticket reporting display 1000 in accordance with some embodiments. After a reporter provides descriptive text associated with a new incident, the framework uses the embodiments described herein to display a list 1010 of potentially related or identical prior tickets. For each prior ticket, the list 1010 might include a ticket identifier and link to the ticket, the ticket’s description, a ticket dated, a ticket priority, a ticket status, etc. The reporter can use the display to search 1020 tickets and sort 1030 the ticket results (e.g., via a touchscreen or computer pointer 1090) before deciding to discard the new ticket 1042 (as being a duplicate), modify the new ticket 1044 (by adjusting the text to emphasize the difference from the prior tickets), create the new ticket 1046 (because it is not, in fact, a duplicate), etc.

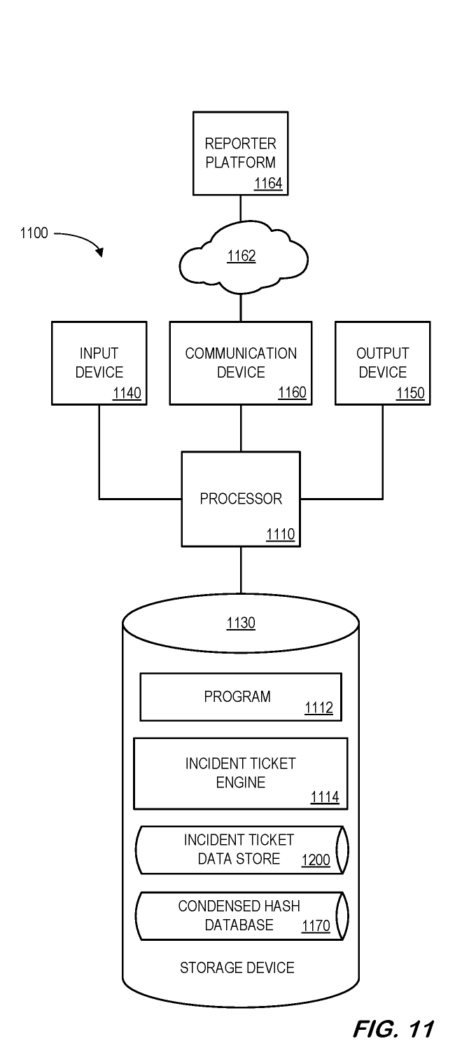

Note that the embodiments described herein may be implemented using any number of different hardware configurations. For example, FIG. 11 is a block diagram of an apparatus or platform 1100 that may be, for example, associated with the system 200 of FIG. 2 (and/or any other system described herein). The platform 1100 comprises a processor 1110, such as one or more commercially available Central Processing Units (“CPUs”) in the form of one-chip microprocessors, coupled to a communication device 1160 configured to communicate via a communication network 1162. The communication device 1160 may be used to communicate, for example, with one or more remote reporter platforms 1164, responder platforms, administrator platforms, etc. The platform 1100 further includes an input device 1140 (e.g., a computer mouse and/or keyboard to input mappings and/or similarity threshold customizations) and/or an output device 1150 (e.g., a computer monitor to render a display, transmit recommendations and alerts, and/or create reports about identification detection results, feedback to improve system performance, etc.).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1112 and/or incident ticket engine 1114 for controlling the processor 1110. The processor 1110 performs instructions of the programs 1112, 1114, and thereby operates in accordance with any of the embodiments described herein. For example, the processor 1110 may perform a hash function on the descriptive text to create a semantic descriptive text hash based on a semantic hashing technique. The semantic descriptive text hash is mapped to a cluster of similar incident tickets, and the incident ticket identifier and mapped cluster are stored in a condensed hash database 1170. A new incident ticket, including new incident ticket descriptive text, is received from a reporter. A hash function is performed by the processor 1110 on the new incident ticket descriptive text to create a semantic descriptive text hash using the same semantic hashing technique. Semantically similar incident tickets can then be determined by the processor 1110 based on clusters in the condensed hash database.

The programs 1112, 1114 may be stored in a compressed, uncompiled and/or encrypted format. The programs 1112, 1114 may furthermore include other program elements, such as an operating system, clipboard application, a database management system, and/or device drivers used by the processor 1110 to interface with peripheral devices.

As used herein, information may be “received” by or “transmitted” to, for example: (i) the platform 1100 from another device; or (ii) a software application or module within the platform 1100 from another software application, module, or any other source.

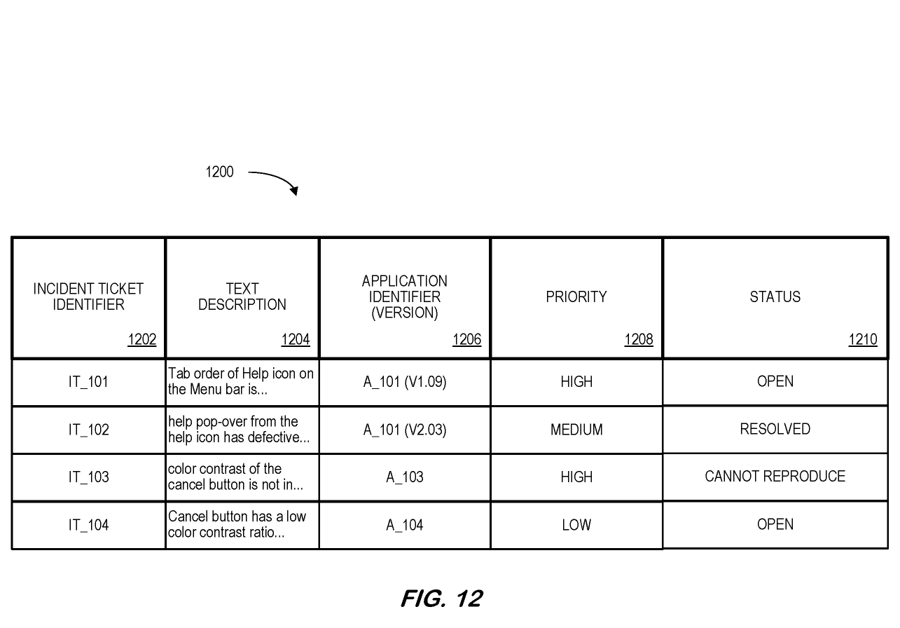

In some embodiments (such as the one shown in FIG. 11), the storage device 1130 further stores the condensed hash database 1170 and an incident ticket data store 1200. An example of a database that may be used in connection with the platform 1100 will now be described in detail with respect to FIG. 12. Note that the database described herein is only one example, and additional and/or different information may be stored therein. Moreover, various databases might be split or combined in accordance with any of the embodiments described herein.

Referring to FIG. 12, a table is shown that represents the incident ticket data store 1200 that may be stored at the platform 1100 according to some embodiments. The table may include, for example, entries identifying ticket information associated with enterprise application incidents. The table may also define fields 1202, 1204, 1206, 1208, 1210 for each of the entries. The fields 1202, 1204, 1206, 1208, 1210 may, according to some embodiments, specify: an incident ticket identifier 1202, a text description 1204, an application identifier and version 1206, a priority 1208, and a status 1210. The incident ticket data store 1200 may be created and updated, for example, when a new incident ticket is created by a reporter, is updated by the system, etc.

The incident ticket identifier 1202 might be a unique alphanumeric label that is associated with a particular enterprise application incident ticket (e.g., generated by a reporter such as a tester). The text description 1204 may be a short description of what the problem is, when it occurs, and other related details. The application identifier and version 1206 may indicate the enterprise application associated with the problem (or a framework that might be the cause of the problem). The priority 1208 might indicate how serious the problem is (high priority, low priority, etc.). The status 1210 might indicate that the incident is still open, has been resolved, could not be reproduced, etc.

In this way, embodiments may improve an incident ticket process for an enterprise to help ensure that a database of incident tickets does not include any comparable past incidents. Prior approaches utilize word-by-word matching and not an NLP based contextual solution. Embodiments may help avoid an incident reporter’s excessive effort in examining previous incidents and developing new ones. Moreover, extra work put in by the development teams to handle numerous duplicate incidents that were reported by various teams for various tests can be avoided. Further, note that more storage for multiple redundant incidents also increases the carbon footprint of a ticketing framework. That is, the carbon footprint grows when more storage is needed for numerous redundant instances. Embodiments described herein may significantly reduce the amount of work that needs to be duplicated by the incident processor and reporter. Because redundant data is not stored, it is a sustainable approach that helps lower the product’s carbon footprint (that is, since less data is stored less energy is used reducing the carbon emission).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

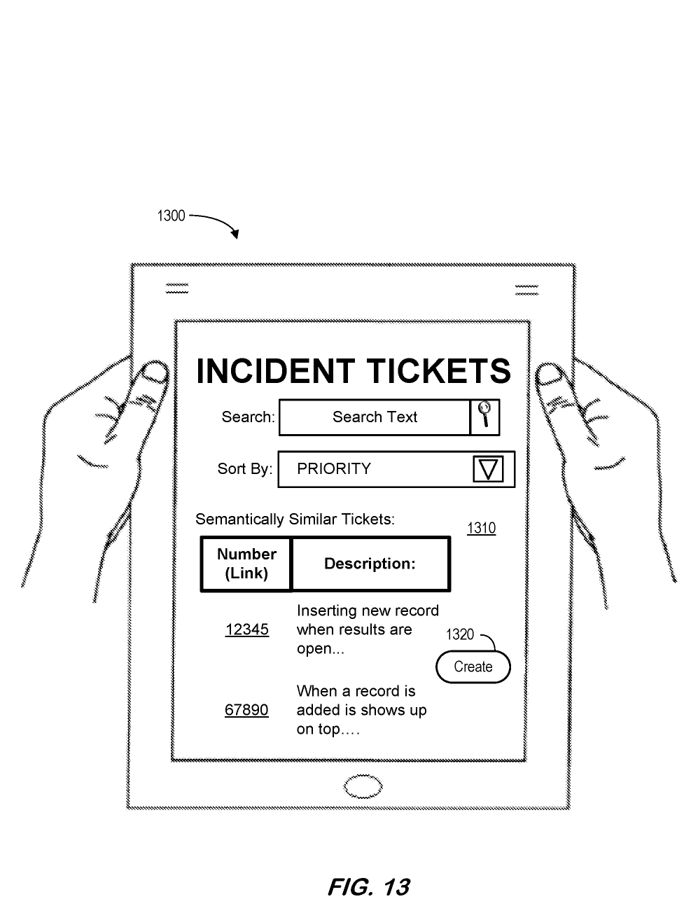

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of business applications, any of the embodiments described herein could be applied to other types of business applications. Moreover, the displays shown herein are provided only as examples, and any other type of user interface could be implemented. For example, FIG. 13 illustrates a tablet computer 1300 providing an incident tickets display 1310 including a lister of semantically similar past incidents, a search function, a sort function, etc. The display 1310 might be used, for example, to investigate aspects of an application problem before a new ticket is generated via selection of a “Create” icon 1320.

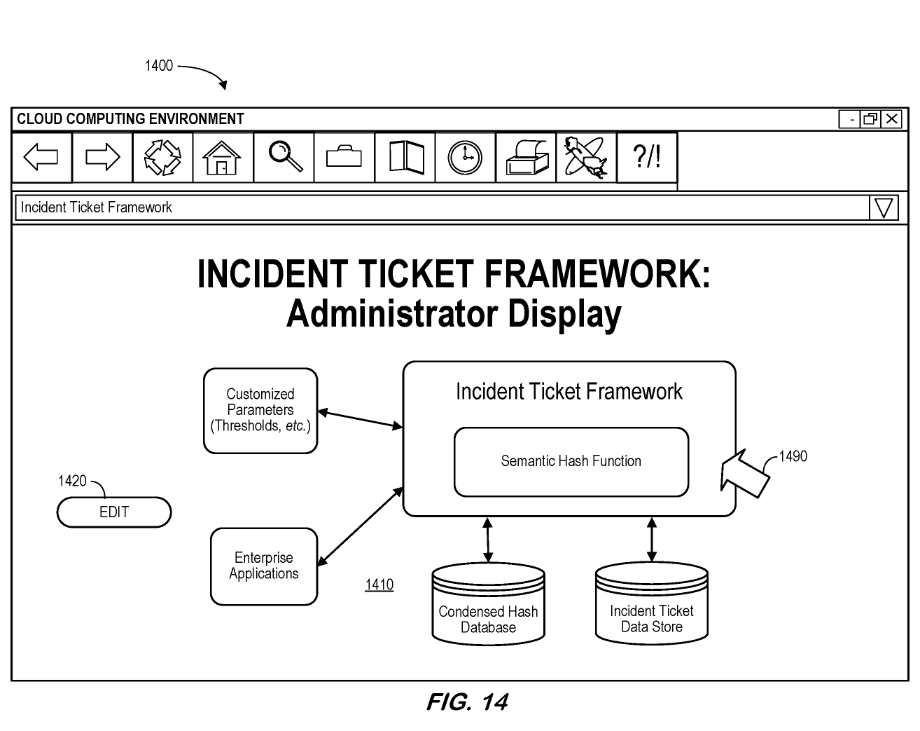

FIG. 14 is an operator or administrator display in accordance with some embodiments. The display 1400 includes a graphical representation 1410 of an incident ticket framework in accordance with any of the embodiments described herein. Selection of an element on the display 1400 (e.g., via a touchscreen or computer pointer 1490) may result in display of a pop-up window containing more detailed information about that element and/or various options (e.g., customized threshold details, mappings to database, reporter and responder communication links, etc.). Selection of an “Edit” icon 1420 may also let an operator or administrator adjust the operation of the system (e.g., to change system mappings, adjust semantic mapping rules or logic, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with incident tickets, comprising:
an incident ticket data store containing electronic records, each record being associated with an enterprise application incident ticket and including an incident ticket identifier and incident ticket descriptive text, and
an incident ticket framework, coupled to the incident ticket data store, including:
a computer processor, and
a computer memory storing instructions that, when executed by the computer processor, cause the incident ticket framework to, for each of a plurality of enterprise application incident tickets, the following steps:
retrieving an incident ticket identifier and incident ticket descriptive text,
performing a hash function on the incident ticket descriptive text to create a semantic descriptive text hash based on a semantic hashing technique,
automatically mapping the semantic descriptive text hash to a cluster of similar incident tickets, and
storing the incident ticket identifier and the mapped cluster in a condensed hash database.

2. The system of claim 1, wherein the incident ticket data store further contains, for each enterprise application incident ticket, supplemental data including at least one of: (i) an enterprise identifier, (ii) an application identifier, (iii) an incident ticket reporter identifier, (iv) an occurrence date, (v) a ticket priority, and (vi) a ticket status.

3. The system of claim 1, wherein the semantic hashing technique is a contextual condensation process that includes a Machine Learning (“ML”) Natural Language Processing (“NLP”) algorithm.

4. The system of claim 3, wherein the contextual condensation process comprises:
creating an address space that includes documents positioned in accordance with a semantic hashing function,
applying the same semantic hashing function to position a new document in the address space, and
determining semantically similar documents based on their proximity to a location of the new document in the address space.

5. The system of claim 4, wherein semantically similar documents are assigned to a cluster of similar incident tickets and stored in the condensed hash database along with the incident ticket identifier.

6. The system of claim 5, wherein supplemental information about documents is included in the semantic hashing function.

7. The system of claim 6, wherein the supplemental information comprises: an enterprise identifier, an application identifier, an incident ticket reporter identifier, an occurrence date, a ticket priority, and a ticket status.

8. The system of claim d1, wherein the incident ticket framework is further to receive, from an incident ticket reporter, a new incident ticket and determine semantically similar incident tickets based on the clusters in the condensed hash database.

9. The system of claim 8, the incident ticket framework is further to provide, to an incident ticket responder, information about the new incident ticket and the semantically similar incident tickets.

10. The system of claim 9, wherein the incident ticket framework is further to automatically generate an alert message and transmit the alert message to at least one of: (i) the incident ticket reporter, and (ii) the incident ticket responder.

11. A computer-implemented method associated with incident tickets, comprising:
receiving, by a computer processor of an incident ticket framework from an incident ticket reporter, a new incident ticket including new incident ticket descriptive text;
performing a hash function on the new incident ticket descriptive text to create a semantic descriptive text hash based on a semantic hashing technique; and
automatically determining semantically similar incident tickets based on the clusters in a condensed hash database.

12. The method of claim 11, wherein the semantic hashing technique is a contextual condensation process that includes a Machine Learning (“ML”) Natural Language Processing (“NLP”) algorithm, comprising:
creating an address space that includes documents positioned in accordance with a semantic hashing function;
applying the same semantic hashing function to position a new document in the address space; and
determining semantically similar documents based on their proximity to a location of the new document in the address space,
wherein semantically similar documents are assigned to a cluster of similar incident tickets and stored in the condensed hash database along with the incident ticket identifier.

13. The method of claim 11, further comprising:
providing information about the semantically similar incident tickets to the incident ticket reporter via a Graphical User Interface (“GUI”).

14. The method of claim 13, wherein the information about the semantically similar incident tickets include links to those incident tickets in an incident ticket data store.

15. The method of claim 13, wherein the information about semantically similar incident tickets is at least one of: (i) searchable by the incident ticket reporter, and (ii) sortable by the incident ticket reporter.

16. The method of claim 11, further comprising:
providing, to an incident ticket responder, information about the new incident ticket and the semantically similar incident tickets.

17. The method of claim 16, further comprising:
automatically generating an alert message; and
transmitting the alert message to at least one of: (i) the incident ticket reporter, and (ii) the incident ticket responder.

18. One or more non-transitory computer-readable media storing computer-executable instructions that, when executed by a computing system, cause the computing system to perform operations comprising:
receiving, by a computer processor of an incident ticket framework from an incident ticket reporter, a new incident ticket including new incident ticket descriptive text;
performing a hash function on the new incident ticket descriptive text to create a semantic descriptive text hash based on a semantic hashing technique; and
automatically determining semantically similar incident tickets based on the clusters in a condensed hash database.

19. The media of claim 18, wherein the semantic hashing technique is a contextual condensation process that includes a Machine Learning (“ML”) Natural Language Processing (“NLP”) algorithm.

20. The media of claim 19, wherein the operations further comprise:
providing information about the semantically similar incident tickets to the incident ticket reporter via a Graphical User Interface (“GUI”);
providing, to an incident ticket responder, information about the new incident ticket and the semantically similar incident tickets;
automatically generating an alert message; and
transmitting the alert message to at least one of: (i) the incident ticket reporter, and (ii) the incident ticket responder.
